(19) United States
(12) Patent Application Publication
(10) Pub. No.: US 2007/0183455 A1
(43) Pub. Date: Aug. 9, 2007

(54) Method of inserting digital watermarks in one-bit audio files

(75) Inventors: Alphons Antonius Maria Lambertus Bruekers, Eindhoven (NL); Franciscus Maria Joannes Willems, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/598,638

(22) PCT Filed: Mar. 4, 2005
(86) PCT No.: PCT/IB05/50806

§ 371 Date: Sep. 7, 2006

(30) Foreign Application Priority Data
Mar. 12, 2004 (EP) 04101019.0

(51) Int. Cl. H04J 1/02

(52) U.S. Cl. 370/493

(57) ABSTRACT

There is described a method of processing a serial data signal to generate a corresponding transformed signal, for example encoded signal. The method includes steps of: (a) providing one or more signature sequences; (b) analysing the serial data signal to determine therein one or more signal sequences for which holds that combining such one or more signal sequences with said one or more signature sequences does not result in generation of illegal states; and (c) combining one or more of the determined signal sequences of the serial data signal with said one or more signature sequences so as to transform the serial data signal into the transformed signal. Moreover, there is also described apparatus (100) operable to execute the method and/or a corresponding inverse method.

### FIELD OF THE INVENTION

The present invention relates to methods of processing serial data signals, for example 1-bit audio data signals. Moreover, the invention also relates to the methods adapted for watermarking purposes. Furthermore, the invention relates to apparatus arranged to implement the method and also data content generated processed or watermarked according to the method.

### BACKGROUND OF THE INVENTION

Analogue signals, for example analogue audio signals, can be sampled in several alternative ways in order to generate corresponding representative digital data. It is conventional practice, for example for contemporary audio compact optical disc data carriers (CD's), to sample audio signals at a sampling rate of fₛ=44.1 kHz and represent them as 16-bit pulse code modulated (PCM) format data. This sampling rate, in view of Nyquist sampling considerations, corresponds to an analogue audio signal bandwidth of substantially 22 kHz. Such sampling is relatively easy to implement using contemporary proprietary integrated circuit chip sets specific adapted for executing such sampling.

An alternative format which is frequently employed is 1-bit format, also known as unity bit coding referred to as direct stream digital (DSD), which is employed in high quality audio reproduction systems, for example in the contemporary Super Audio CD (SACD). In SACD systems, the sampling frequency employed is increased to 64 fₛ to generate a serial sequence of 1-bit data samples. In such a sequence, each sample having a value of logic 1 or 0 representing real signal states of +1, −1 respectively subject to normalization. Conventionally, 1-bit sample data is frequently generated using a Sigma-Delta modulator. The audio bandwidth provided by 1-bit sampling at a sampling rate of 64 fₛ extends up to 100 kHz.

Unauthorised copying of proprietary audio data content is a known problem, for example as in counterfeiting and pirate copying, which potentially financially affects music recording companies. Moreover, such copying can arise from copying data directly from one data carrier to another, as well as from data content distribution via communication networks such as the Internet. In order to try to discourage such unauthorised copying, it is conventional practice to include watermarking in proprietary audio data content so that routes of distribution and copying of data content can be ascertained and measures taken to deter such copying, for example by imposition of fines or levies.

It is known to include watermark data in unit-bit coded (DSD) audio signals. For example, in a published United States patent application no. US 2001/0066408, there is described conversion of an original high-quality 1-bit coded (DSD) audio signal having a 2.822 MHz bit rate to a PCM signal of relatively lower sampling rate by means of a sample rate converter. A watermark signal is embedded into the PCM signal by using a conventional PCM watermark embedder. Subsequently, the watermarked PCM signal is re-converted back to a 1-bit coded format signal for purposes of generating a final watermarked 1-bit coded signal. The inventors have appreciated that this watermarking approach is potentially costly and complex and therefore have endeavoured to provide a more direct and potentially simpler method of including a watermark signal with unit-bit coded sample data.

### SUMMARY OF THE INVENTION

An object of the invention is to provide an alternative method of including watermark information in a 1-bit coded data signal.

According to a first aspect of the present invention, there is provided a method of processing a serial data signal to generate a corresponding transformed signal, the method including the steps of:

(a) providing one or more signature sequences;

(b) analysing the serial data signal to determine therein one or more signal sequences for which holds that combining such one or more signal sequences with said one or more signature sequences does not result in generation of illegal states; and

(c) combining one or more of the determined signal sequences of the serial data signal with said one or more signature sequences so as to transform the serial data signal into the transformed signal.

The invention is of advantage in that it is capable of enabling the serial data signal to be directly transformed to generate the transformed signal without there being a need to convert the serial data signal to another intermediate format for processing purposes.

By “combining” or “combination” refers to a mathematical process including, but not limited thereto, one or more of: addition, subtraction, exclusive-OR. Moreover, “illegal states” refers to states arising from combining the serial data signal and one or more of the signature sequences, these states not being accommodated in a format pertaining to the transformed signal; such illegal states are susceptible to giving rise to information loss when the transformed signal is subsequently processed to regenerate the serial data signal. Furthermore, “desired illegal states” in the context of the present invention refers to where a certain degree of irreversible degradation is desired, for example for providing degraded music samples as a preliminary to providing a corresponding non-degraded music sample in return for payment.

The present invention is not limited to serial binary data streams for processing to generate corresponding transformed signals, but is equally applicable to signals with three or more states. Moreover, the invention is also applicable to parallel data streams, for example 16-bit data buses, wherein each individual stream is susceptible to being processed according to the invention to generate one or more corresponding transformed data streams.

Preferably, in the method, the serial data signal is a 1-bit data signal in binary format, and the one or more signature sequences are arranged to be directly combinable with the serial data signal to generate the transformed signal in binary format, preferably such combination involving addition and/or subtraction and/or exclusive-OR operations.

The invention is of benefit in that it is not necessary to convert the 1-bit signal to other formats to generate the corresponding transformed signal. More preferably, the serial data signal is arranged such that its series of symbols have substantially similar significance; hitherto, it is been difficult to watermark such data, for example by spoilation of least significant bits, without converting the data to a hierarchical bit format, for example PCM.

Preferably, in the method, the one or more signature sequences are useable to reversibly transform the transformed signal to regenerate a copy of the serial data signal therefrom. Such reversibility is of benefit in situations where when degraded sample data are issued substantially free-of-charge to potential customers such that, on subsequently payment of a fee, the customers are provided with a decryption key for decoding the degraded sample data. However, the invention is also applicable in a mode where the degraded sample is irreversibly degraded by applying the method of the invention and allowing for the generation of at least some illegal states in the transformed signal giving rise to irreversible information loss. In such a situation, there can arise illegal states which are desired for irreversibly degrading the free-of-charge sample and hence is encompassed by the scope of the present invention.

Preferably, in the method, a plurality of signature sequences is employed in the method. Use of a plurality of signature sequences enables complex encoding to be performed, for example watermarking which is non-trivial to circumvent.

Preferably, in the method, the one or more signature sequences are each two or more symbols long. Whereas relatively shorter sequences can be included frequently in the transformed data on account of numerous locations at which the shorter sequences match that of the serial data signal, longer sequences are susceptible to being more specific and therefore their occurrence in the transformed data corresponds to greater information content. More preferably, in the method the one or more signal sequences for which holds that combining such one or more signal sequences with said one or more signature sequences does not result in generation of illegal states are selected according to a perceptual model to obtain a preferred perceived characteristic in the transformed signal; such a selective approach enables watermarks to be applied to audio data in a manner which is least subjectively obtrusive to listeners and yet is easily detectable for counterfeit identification purposes.

Preferably, in the method, the serial data signal and the transformed signal are 1-bit audio signals, and the combination of the one or more signature sequences is performed directly on the serial data signal without transforming to another signal format. The method therefore is of advantage in that it can be applied directly to 1-bit audio signals for signal processing purposes without need to translate the serial data signal into other signal formats.

Preferably, the method is arranged to embed a watermark in the serial data signal so that the transformed signal is a watermarked version of the serial data signal. More preferably, insertion of the watermark is executed by a sound recording manufacturer and/or and sound recording distributor, for example an Internet web site configured to deliver data music files in return for payment.

According to a second aspect of the invention, there is provided an apparatus for implementing the method according to the first aspect of the present invention, the apparatus being arranged to receive the serial data signal and output the transformed data.

According to a third aspect of the present invention, there is provided transformed data generated using the method according to the first aspect of the invention. The transformed data is preferably supplied on a data carrier, for example an optical disc data-carrying medium, and/or via a communication network, for example the Internet.

According to a fourth aspect of the present invention, there is provided computer software operable when executed on a computing device to implement the method according to the first aspect of the present invention.

According to a fifth aspect of the present invention, there is provided a method of processing a transformed signal to regenerate a corresponding decoded serial data signal, the method including the steps of:

(a) providing one or more signature sequences;

(b) analysing the transformed signal to determine therein one or more signal sequences for which holds that combining such one or more signal sequences with said one or more signature sequences does not result in generation of illegal states; and

(c) combining one or more of the determined signal sequences of the transformed signal with said one or more signature sequences so as to transform the transformed signal to regenerate therefrom the decoded serial data signal.

According to a sixth aspect of the present invention, there is provided an apparatus for implementing the method according to the fifth aspect of the invention, the apparatus being operable to receive the transformed data signal and output the decoded serial data signal data.

According to a seventh aspect of the present invention, there is provided computer software operable when executed on a computing device to implement the method according to the fifth aspect of the invention.

It will be appreciated that features of the invention are susceptible to being combined in any combination without departing from the scope of the invention.

### DESCRIPTION OF THE DIAGRAMS

Embodiments of the invention will now be described, by way of example only, with reference to the following diagrams wherein:

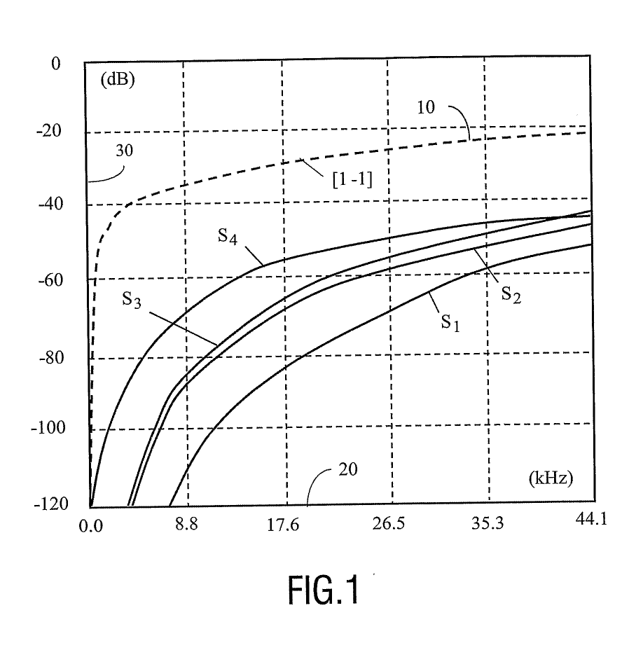

FIG. 1 is a graph illustrating spectral characteristics of a subset of sequences selected from Table 1, including a trivial sequence [1, −1] for comparison;

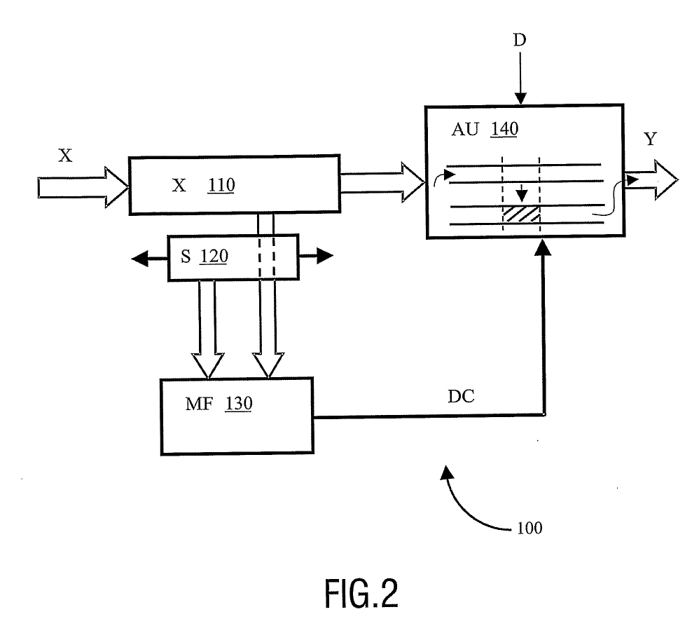

FIG. 2 is an apparatus according to the invention for implementing a method according to the invention;

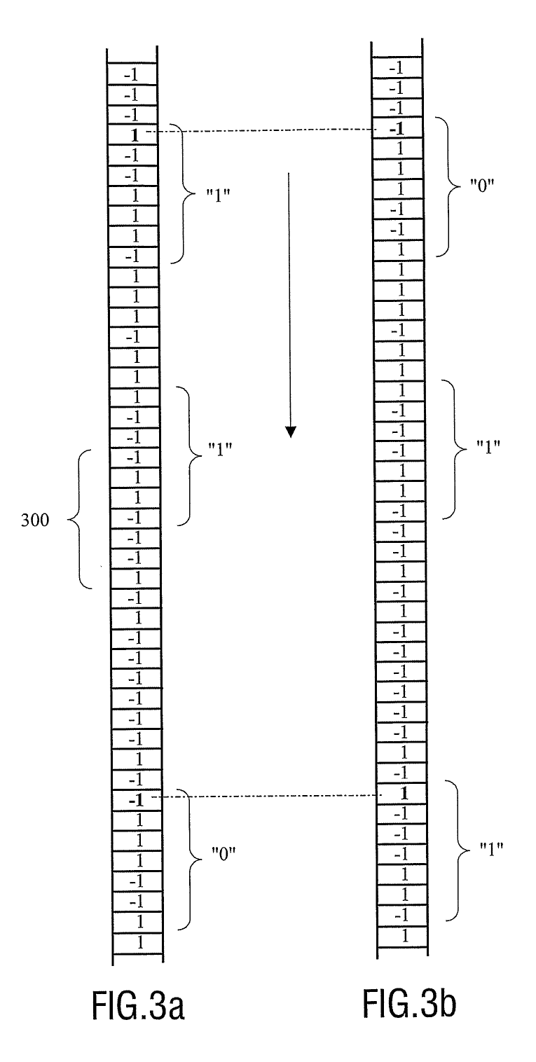

FIGS. 3a, 3b are illustrations of two sequences being analysed for 0-matching or 1-matching according to the invention;

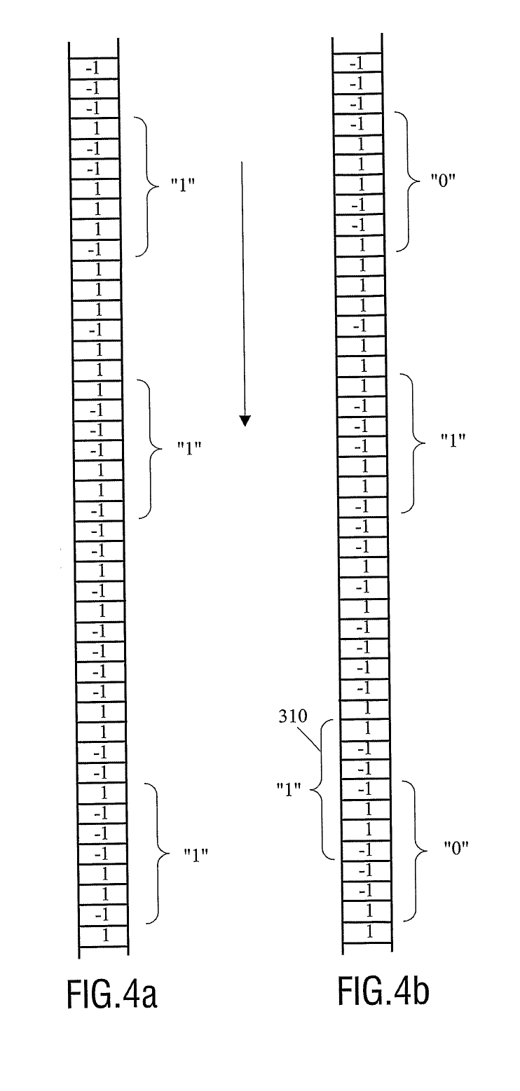

FIGS. 4a, 4b are illustrations of two sequences being analysed for 0-matching or 1-matching where a change of relatively few bits can significantly alter information conveyed, for example for watermarking purposes; and

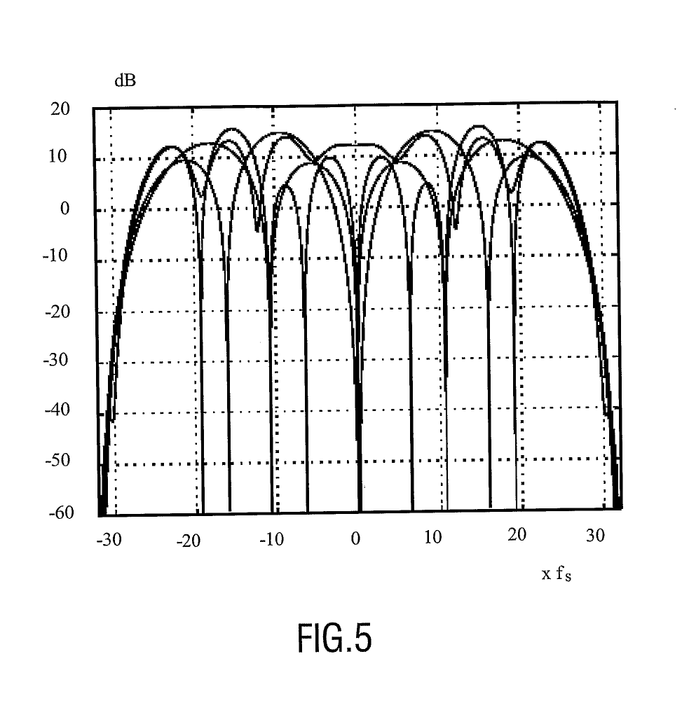

FIG. 5 is a graph of spectra corresponding to four best sequences Sε{−1,0,+1}¹² exhibiting a minimal disturbance around a frequency f=32 fₛ where fₛ is a sampling frequency, said sequences being selected from Table 2;

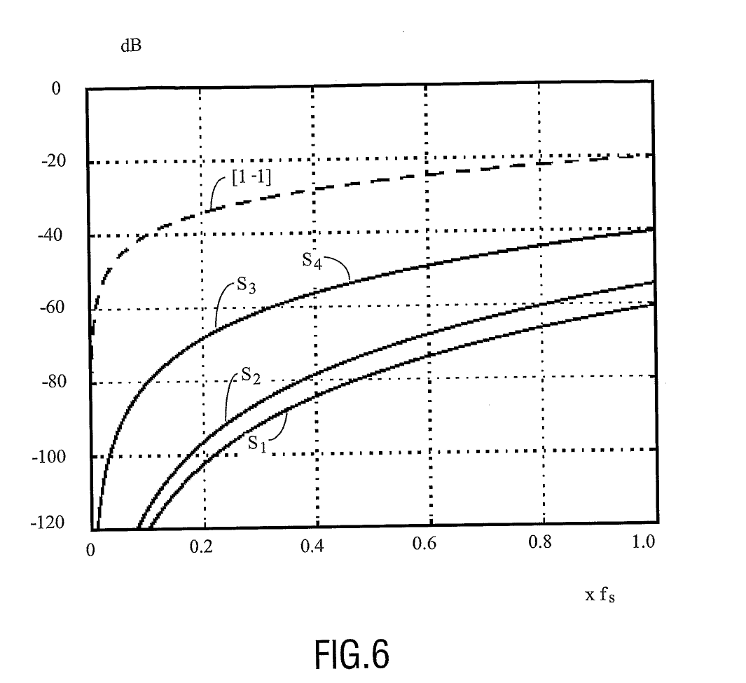

FIG. 6 is a graph of spectra corresponding to four best sequences Sε{−3,−2,−1,0,+1,+2,+3}⁵ with a spectrum of a sequence S=[1,−1] included as a broken line for comparison;

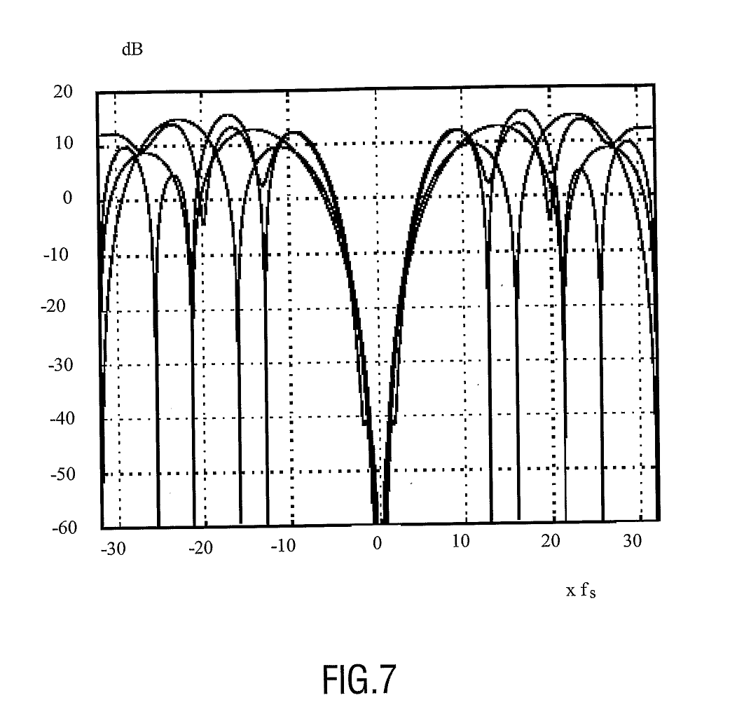

FIG. 7 is a graph of spectra corresponding to four best sequences Sε{−1,0,+1}¹² exhibiting a minimal disturbance around a frequency f=0 Hz; and

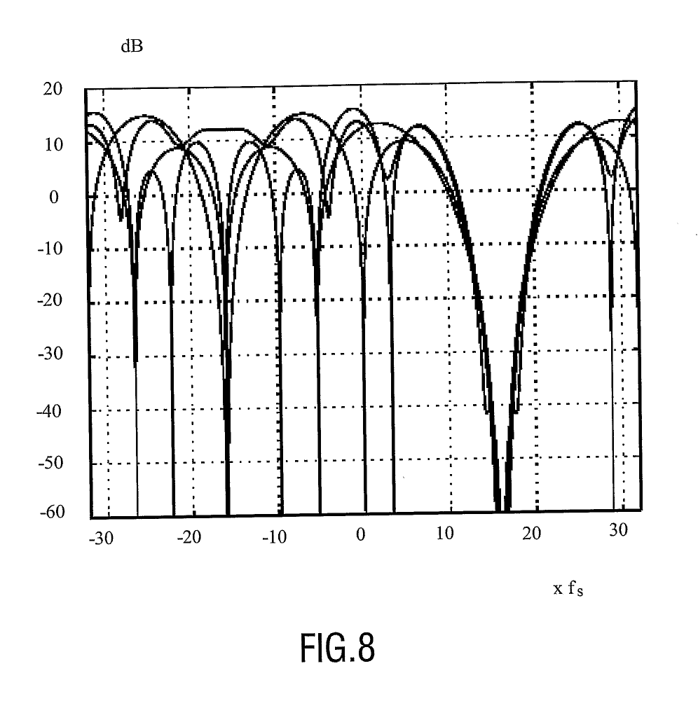

FIG. 8 is a graph of four best sequences from Table 2 subject to modulation using a complex carrier c[n]=jⁿ.

### DESCRIPTION OF EMBODIMENTS OF THE INVENTION

In devising the present invention, the inventors have envisaged that it is not permitted in general simply to add two 1-bit audio signals, each signal comprising a sequence of symbols having values 1 or 0, because their corresponding symbol states of 1 and −1 respectively can potentially sum to any one of three values, namely −2, 0, +2. Even after scaling by a factor of 2, such values no longer conform to the aforementioned DSD format for 1-bit sample signals and are considered in the context of the present invention to be illegal states.

The inventors have appreciated that when a 1-bit sample signal is to have added directly thereto watermark information, when the sample signal has a state −1, a watermark signal value of 0 or +2 may be added to it. Similarly, when the sample signal has a state +1, a watermark signal value of 0 or −2 may be added to it. Thus, if a signature sequence (hereinafter also referred to as watermark sequence) is devised comprising states of −2, 0, 2, such a signature sequence is susceptible to being directly added to a 1-bit DSD audio signal to generate a subsequently watermarked 1-bit audio signal in conformity with the DSD standard.

1-bit audio signal sequences X will be represented in square brackets in Equation 1a (Eq. 1a). They have symbols whose states as defined by Equation 1b (Eq. 1b).
X=[v₁,v₂, . . . ,vₙ₋₁,vₙ] Eq. 1a
Xε{0,1}^{k} Eq. 1b
where
v=a symbol in the sequence X, the symbol v having logic values of 1 or 0 corresponding to symbol states of +1 and −1; such that v's subscripts are indicative of a temporal sequence of the symbols v, namely there are n symbols in the sequence V with symbol v₁ being temporally first and symbol vₙ being temporally last; and
k=a positive integer.

As explained above, given watermark sequences may be added to some but not all signal sequences X. For example, adding a watermark sequence S=[1, −1] to signal sequence X=[−1, 1] according to Equation 2 (Eq. 2) results in a legal watermarked sequence Y:
Y=X+2S=[1,−1] Eq. 2

Addition of this particular watermark signal S to the sequence signal X implemented as a 1-bit audio signal corresponds temporally locally to a multiplication of −1. For X being a 1-bit audio signal sequence, such local multiplication does not change the low-frequency component of the watermarked signal Y significantly in comparison to the original 1-bit audio signal X, but results in relatively major higher frequency artefacts. Such a change in higher-frequency energy is illustrated in FIG. 1. In this Figure, there is included an abscissa axis 20 corresponding to a frequency range from 0 kHz to 44.1 kHz, and an ordinate axis 30 corresponding to signal frequency component spectral amplitude. Reference numeral 10 denotes the increased noise across the audio spectrum introduced by adding the watermark sequence S=[1, −1].

The inventors have appreciated that there are more sequences S that may be added to the signal X=[−1, 1] which still yield a corresponding binary signal Y devoid of illegal states. One such sequence is S=[1, 0], and another is S=[0, −1]. A zero in the sequence S implies that a corresponding sample in the signal X may have a signal value of −1 or +1. However, these sequences are less suitable in view of the distortion they introduce in digital audio signals. Obviously, the sequences S=[0], S=[0,0], S=[0,0,0] etc. are not of practical use.

The signature sequence S=[1, −1] may not be added to signal sequences X other than [−1, 1] because a non-compliant non-binary corresponding signal Y would result, namely an illegal result. However, the sequence may be subtracted from a signal sequence [1, −1] of the signal X; equivalently, a corresponding negated sequence S=[−1, 1] may be added to a sequence [1, −1] in the signal X. Addition of such sequences does not affect distortion arising within a signal as its frequency spectrum for low frequencies is not altered appreciably by such addition.

Other signal sequences X require other signature sequences, for example the watermark sequence S=[−1, −1] may be added to a signal sequence X=[1, 1]. However, the sequence S=[−1, −1] has a significant effect in the low frequency region of the signal X when combined therewith. Combining such a sequence to a 1-bit audio signal, for example by adding to an aforementioned DSD signal, would result in unacceptable distortion for watermarking purposes. Alternative watermarking sequences such as S=[0, −1] or S=[−1, 0] are also not suitable for use in watermarking.

It appears that the watermark sequence [1, −1] is far from optimal. The inventors have considered a large number of signature sequences of various lengths and evaluated their impact on the audio signal quality. The following Table 1 lists such signature sequences Sᵢ up to length 12. A value R in the Table corresponds to the ratio of energy of an associated sequence in a frequency band from 0 Hz to the sampling frequency fₛ, and the sequence being a unit pulse. The unit pulse itself is included in the Table 1 as S₄₂. The sequences Sᵢ are listed in order of ascending order of R. For comparison, the table also includes the above mentioned sequence S=[1, −1], viz. S₄₁.

The graphs S₁, S₂, S₃, S₄ in FIG. 1 denote the increased noise spectra associated with the first four signature sequences listed in Table 1. It will be appreciated that they are far more suitable for watermarking purposes than the “simple” sequence S₄₁=[1, −1] described above.

TABLE 1
Example signature sequences for 1-bit audio signals

| i | Sequence Sᵢ | | | | | | | | | | | | R(dB) |
|---|---|---|---|---|---|---|---|---|---|---|---|---|---|
| 1 | 1 | −1 | −1 | 0 | 1 | 0 | 0 | 1 | 0 | −1 | −1 | 1 | −60.77 |
| 2 | 1 | −1 | −1 | 0 | 1 | 1 | −1 | | | | | | −53.42 |
| 3 | 1 | −1 | −1 | 1 | −1 | 1 | 1 | −1 | | | | | −50.94 |
| 4 | 1 | −1 | 1− | 1 | −1 | 1 | 0 | 1 | 0 | −1 | −1 | 1 | −49.26 |
| 5 | 1 | −1 | −1 | 0 | 1 | 0 | 1 | −1 | 1 | −1 | −1 | 1 | −49.26 |
| 6 | 1 | −1 | −1 | 1 | 0 | −1 | 1 | 1 | −1 | | | | −49.03 |
| 7 | 1 | −1 | −1 | 0 | 1 | 0 | 1 | 0 | −1 | −1 | 1 | | −48.86 |
| 8 | 1 | −1 | −1 | 1 | 0 | 0 | −1 | 1 | 1 | −1 | | | −47.47 |
| 9 | 1 | −1 | 0 | −1 | 0 | 1 | 0 | 1 | −1 | | | | −47.43 |
| 10 | 1 | −1 | −1 | 1 | 0 | 0 | 0 | −1 | 1 | 1 | −1 | | −46.17 |
| 11 | 1 | −1 | −1 | 0 | 1 | 0 | 1 | −1 | | | | | −45.59 |
| 12 | 1 | −1 | 0 | −1 | 0 | 1 | 1 | −1 | | | | | −45.59 |
| 13 | 1 | −1 | 0 | −1 | 1 | −1 | 1 | 0 | 1 | −1 | | −1 | −45.52 |
| 14 | 1 | −1 | −1 | 1 | 0 | 0 | 0 | 0 | −1 | 1 | 1 | | −45.05 |
| 15 | 1 | −1 | −1 | 1 | −1 | 1 | 0 | 1 | −1 | | | | −44.74 |
| 16 | 1 | −1 | 0 | −1 | 1 | −1 | 1 | 1 | −1 | | | | −44.74 |
| 17 | 1 | −1 | 0 | −1 | 1 | 0 | −1 | 1 | 0 | 1 | −1 | | −43.97 |
| 18 | 1 | −1 | 0 | −1 | 1 | 0 | −1 | 1 | 1 | −1 | | | −43.88 |
| 19 | 1 | −1 | −1 | 1 | 0 | −1 | 1 | 0 | 1 | −1 | | | −43.88 |
| 20 | 1 | −1 | 0 | −1 | 0 | 1 | 0 | 0 | 1 | −1 | | | −43.15 |
| 21 | 1 | −1 | 0 | 0 | −1 | 0 | 1 | 0 | 1 | −1 | | | −43.15 |
| 22 | 1 | −1 | −1 | 1 | 0 | 0 | −1 | 1 | 0 | 1 | −1 | | −43.04 |
| 23 | 1 | −1 | 0 | −1 | 1 | 0 | 0 | −1 | 1 | 1 | −1 | | −43.04 |
| 24 | 1 | −1 | 0 | 0 | −1 | 0 | 1 | 0 | 0 | 1 | −1 | | −43.04 |
| 25 | 1 | −1 | 0 | −1 | 1 | 0 | 0 | −1 | 1 | 0 | 1 | −1 | −42.66 |
| 26 | 1 | −1 | −1 | 1 | −1 | 1 | 1 | −1 | 1 | −1 | −1 | 1 | −42.31 |
| 27 | 1 | −1 | −1 | 1 | 0 | 0 | 0 | −1 | 1 | 0 | 1 | −1 | −42.24 |
| 28 | 1 | −1 | 0 | −1 | 1 | 0 | 0 | 0 | −1 | 1 | 1 | −1 | −42.24 |
| 29 | 1 | −1 | −1 | 1 | 0 | −1 | 1 | 1 | 0 | −1 | −1 | 1 | −42.24 |
| 30 | 1 | −1 | −1 | 0 | 1 | 1 | −1 | 0 | 1 | −1 | −1 | 1 | −42.24 |
| 31 | 1 | −1 | 0 | −1 | 0 | 1 | 0 | 1 | 0 | −1 | −1 | 1 | −42.23 |
| 32 | 1 | −1 | −1 | 0 | 1 | 0 | 1 | 0 | −1 | 0 | −1 | 1 | −42.23 |
| 33 | 1 | −1 | −1 | 1 | 1 | −1 | −1 | 0 | 1 | 0 | 1 | −1 | −42.13 |
| 34 | 1 | −1 | 0 | −1 | 0 | 1 | 1 | −1 | −1 | 1 | 1 | −1 | −42.13 |
| 35 | 1 | −1 | −1 | 1 | −1 | 1 | 1 | 0 | −1 | −1 | 1 | | −42.05 |
| 36 | 1 | −1 | −1 | 0 | 1 | 1 | −1 | 1 | −1 | −1 | 1 | | −42.05 |
| 37 | 1 | −1 | 0 | 0 | −1 | 1 | −1 | 1 | 0 | 1 | −1 | | −42.00 |
| 38 | 1 | −1 | 0 | −1 | 1 | −1 | 1 | 0 | 0 | 1 | −1 | | −42.00 |
| 39 | 1 | −1 | −1 | 0 | 1 | 1 | 0 | −1 | −1 | 1 | | | −41.86 |
| 40 | 1 | −1 | 0 | 0 | −1 | 1 | −1 | 1 | 0 | 0 | 1 | −1 | −41.49 |
| 41 | 1 | −1 | | | | | | | | | | | −24.93 |
| 42 | 1 | | | | | | | | | | | | 0 |

Note that all the example sequences in Table 1 commence with a normalized value 1. There inverse counterparts are equally useable, but are not shown in the Table. Note further that the sequences have been evaluated for a particular application (here: watermarking of DSD audio). For other applications, other sequences will be optimal.

In order to further described the present invention, a nomenclature as provided in Equation 3 (Eq. 3) will be adopted in the following:

$${{S}^{Λ}}_{i} = {\sum }_{n} \vert {S}_{i} [ n ] \vert \qquad Eq . 3$$

where Sᵢ[n] is a watermark sequence and n is the index of symbols in the sequence.

The inventors have introduced the expression “matching sequences”. A signal sequence X is said to “match” a given signature sequence Sᵢ if Sᵢ can be combined with X (e.g. added to X or subtracted from X) without introducing illegal states. Mathematically, a signal sequence is matching if the absolute inner product | [symbol] X,Sᵢ [symbol] | equals [symbol] ᵢ. More particularly, if [symbol] X,Sᵢ [symbol] = [symbol] ᵢ, the sequence X is said to be “1-matching”. Conversely, if [symbol] X,Sᵢ [symbol] = [symbol] ᵢ, the sequence X is said to be “0-matching”.

Equation 4 (Eq. 4) below shows that the signature sequence Sᵢ (or mathematically more precisely: 2Sᵢ) can be subtracted from a 1-matching signal sequence X. Such subtraction causes a watermarked sequence Y to be generated. [symbol]
X,Sᵢ=ᵢX−2Sᵢ=Y Eq.4
Note that subtraction turns the 1-matching sequence X into a 0-matching sequence Y.

Similarly, Equation 5 (Eq. 5) below shows that the signature sequence Sᵢ can be added to a 0-matching signal sequence X. [symbol]
X,Sᵢ=−ᵢX+2Sᵢ=Y Eq. 5
Note that addition turns the 0-matching sequence X into a 1-matching sequence Y.

In accordance with the invention, a signal is now processed by inspecting it for occurrences therein of sequences X that match a predetermined signature sequence Sᵢ (or a plurality of predetermined signature sequences). It will be appreciated that signal symbols corresponding to “0” states in the signature sequence Sᵢ can be superficially regarded as “don't care” values in such a search process. Where matching sequences X occur, they are modified in accordance with a given processing algorithm.

For example, in accordance with one aspect of the invention, a 1-bit audio signal to be watermarked is analysed for occurrences of signal sequences X that match a given signature sequence Sᵢ. The series of occurrences of matching sequences in the audio signal is considered to constitute a data channel. More particularly, the occurrence of a 1-matching sequence is considered to constitute a data bit ‘1’, and the occurrence of a 0-matching sequence is considered to constitute a data bit ‘0’. This is illustrated in FIG. 3a, where a 1-bit audio signal to be watermarked is analysed for occurrences of length-7 sequences X that match the length-7 signature sequence S₂=[1, −1, −1, 0, 1, 1, −1]. The Figure shows that a data message ‘110’ may be considered to be embedded or buried in the audio signal.

Obviously, the data channel in FIG. 3a conveys random data, because the data bits are derived from arbitrary audio content. Therefore, in a data embedding stage, the audio signal is modified to convey a desired data message. If the data bit to be embedded is ‘0’, then the embedding stage modifies a 1-matching sequence into a 0-matching sequence by subtracting therefrom the signature sequence S₂. Similarly, if the data bit to be embedded is ‘1’, then the embedding stage modifies a 0-matching sequence into a 1-matching sequence by adding thereto the signature sequence S₂. Obviously, a matching sequence X is not modified if it already represents the data bit to be embedded. FIG. 3b illustrates how the DSD audio signal, which is shown in FIG. 3a, has been modified in this manner to obtain a watermarked audio signal having a desired embedded data message ‘011’.

An embodiment of the arrangement according to the invention will now be described with reference to FIG. 2. A watermarking apparatus is indicated generally by 100 and comprises a first store (X) 110 for receiving a 1-bit audio signal X, a second store (S) 120 for storing a watermark sequence S, and a matching function (MF) 130 for comparing sequences of the signal X with the watermark S to determine occurrences of matches of the watermark S to the signal X as described in the foregoing. There is thereby generated a data channel (DC) indicative of where matches occur in the signal X. The apparatus 100 further includes an arithmetic unit (AU) 140, which receives a desired data message D to be embedded. The unit 140 is arranged to combine the signals X and S, namely by adding or subtracting the watermark sequence S to matching sequences X, as appropriate without violating the aforementioned rules so as to generate a watermarked output signal Y in the 1-bit format. Preferably, the apparatus 100 is implemented using computing devices. Alternatively, it can be implemented in dedicated logic hardware, for example using an application specific integrated circuit (ASIC).

The sequence S in the apparatus 100, for example, is a 7-symbol long sequence S=[1, −1, −1, 0, 1, 1, −1]. The input signal X is preferably a DSD audio signal. The matching function MF 130 is operable to inspect occurrences of matching sequences in the signal X corresponding to the 7-symbol watermark sequence. In one embodiment of the invention, the data channel (DC) is indicative of where matches occur in the signal X. More particularly, an occurrence of a 1-matching sequence is considered to constitute a data bit “1” in the data channel DC; likewise, an occurrence of a 0-matching sequence is considered to constitute a data bit “0” in the channel DC. Such identification of matches is shown in FIG. 3a which shows that a data sequence “110” is considered to be embedded or buried in the DSD signal X. Moreover, the data channel DC in such a situation is considered to be random data, because its data bits are derived from arbitrary audio content of a substantially pseudo-random nature.

When the apparatus 100 is to embed “0” data in a 1-bit serial audio signal, the AU 140 modifies a 1-matching sequence into a 0-matching sequence by subtracting the watermark sequence S therefrom. Similarly, when the apparatus 100 is to embed “1” data in a 1-bit serial audio signal, the AU 140 modifies a 0-matching sequence into a 1-matching sequence by adding the watermark S thereto. The matching sequence X is not modified if it already represents a particular data bit to be embedded.

In the aforesaid embodiment of the invention in FIG. 2, a running window of 7-symbols length is used to detect matching sequences. As shown in FIGS. 3a and 3b, this results in matching sequences which are not uniformly spaced apart. It is also potentially possible to identify occurrences of sequences which overlap. An example of such overlap is illustrated in FIG. 3a and denoted by 300. In the apparatus 100, overlapping sequences are preferably ignored. Another potential problem of employing such a running window is illustrated in FIGS. 4a and 4b. A signal shown in FIG. 4a contains the data sequence “111”. By appropriate subtraction of sequence S the signal is modified to contain the data sequence “010” shown in FIG. 4b. However, changing the third 1-matching sequence into a 0-matching sequence causes an occurrence of an earlier 1-matching sequence 310 as shown in FIG. 4b. Such overlapping problems can be at least partially circumvented by not employing a running window as depicted in the apparatus 100 in FIG. 2, but dividing the signal X into successive non-overlapping regions which are individually searched for occurrence of matching sequences therein.

Thus, in overview, the method of the present invention concerns an approach to embedding watermark information in 1-bit programme data content by performing a combining operation, for example as depicted in Equation 2 for changing signal data from a positive sense to a negative sense in response to a sequence of bits present in the original programme data content. An effect of the watermarking is to degrade watermarked signal-to-noise and/or distortion characteristics, especially at relatively higher frequencies, for example at upper frequencies of the audio band wherein the sequence corresponds to digital audio data.

The inventors have appreciated that it is feasible to embed additional data into a 1-bit audio signal generated in a contemporary Sigma-Delta modulator by overruling a splicer output included of the modulator. The additional data can be input in respect of a temporal grid, namely temporal frame of reference. However, such an approach is potentially disadvantageous because stability conditions of a feedback loop employed within the Sigma-Delta modulator may potentially be violated.

In the method of the invention, watermark data is preferably not inserted into the feedback loop of the aforementioned Sigma-Delta modulator, so that stability issues do not arise.

In the method, for a particular sequence X corresponding to a 1-bit audio data stream, the sequence X is searched with respect to a watermark sequence Sᵢ for identifying matches which result in a random series of 1-matches and 0 matches; for example, in Equation 2, the sequence Sᵢ is effectively compared at various positions along the signal X to search for identifying matches. The series of matches can be considered as a data channel. Thus, when processing the signal data X in Equation 2 to generate a watermarked signal data Y by using a watermark data S, a 0-match is replaced by a 1-match in a case when a 1-digit has to be embedded if a 0-digit is present. Similarly, a 1-match is replaced by a 0-match in a case when a 0-digit has to be embedded if a 1-digit is present.

Preferably, for ease of processing, the method is arranged to assume that two adjacent matching sequences in the signal X should be non-overlapping; namely, the method can be arranged to disregard matched sequences in the signal X relative to the watermark data S which overlap. However, in order to improve watermarked signal quality, a minimum distance can optionally be set for successive matches which are allowed to cause modification of the signal X to generate the signal Y.

Positions along the signal data X, at which matches are identified in FIG. 2 and which result in a corresponding negation change in the sequence of the data X to generate the signal data Y, is preferably distributed so as to result in a particular type of disturbance as perceived, for example by human listening, in the watermarked signal Y. Skipping modification of parts of the signal X to generate the signal Y depending on matches with the watermark data S is preferable executed under control of an aural perceptual model, for instance a mathematical model whose parameters are determined from human aural perception tests.

In the method, it will be appreciated that more than one watermarking sequence Sᵢ can be optionally utilized for watermarking purposes. A communication protocol is preferably employed, for example marker data, so that a plurality of watermarking sequences can be employed in processing the signal X to generate the corresponding watermarked signal Y; the marker data is preferably indicative of switches from one watermarking sequence to another. Such a plurality of watermarking sequences can be preferentially dynamically selected so as to enhance audio quality whilst also allowing for inclusion of the watermark signal.

On account of the aforementioned method of the invention being most appropriate only for certain types of signal data, for example audio data, it is to be regarded as a relatively “fragile” type of scheme in comparison to robust schemes which are applicable to all types of data, for example complex general-purpose encryption methods.

For PCM types of signals, it is a known procedure to degrade signal quality by “spoiling” one or more least significant bits in each data sample. Such spoiling can be implemented to be reversible using a cryptographic algorithm arranged so that, if the key is known, an original high-quality un-degraded signal can be reconstituted by using the key. Such spoilation applied to high-quality PCM signals is beneficially used for generating corresponding lower quality degraded signals; potential customers can be permitted free-of-charge to evaluate the lower quality signals and then elect to purchase one or more keys for decrypting the lower quality signals to regenerate the corresponding high-quality signals therefrom. Such distribution is especially pertinent to music data content distributed via communication networks, for example via the Internet.

However, such approaches to signal spoilation with associated decryption keys is not readily applicable to 1-bit audio signals as described in the foregoing, for example the signal X, on account of the bits in the sequence X all having a comparable degree of significance. The present invention is however of benefit, for example, in reversibly degrading 1-bit audio signals to generate degraded quality signals for free-of-charge distribution to entice potential customers. Such encryption can be achieved, for example, by replacing aforementioned 0-matches with 1-matches and vice versa, preferably using a secret watermarking sequence. During decryption, toggling under control of the same sequence is repeated, thereby restoring a 1-bit degraded audio signal to its original high-quality form. When reversible spoilation of a 1-bit signal is envisaged, it is not necessary to optimize using sequences Sᵢ which result in relatively little energy in the audio bandwidth of the signal X. Preferably, different sequences Sᵢ can be utilized which result in different apparent degrees of signal degradation. Such different sequences can be arranged to be dynamically changeable, for example under control of data in a control channel.

The method of the invention can be regarding as a process of selectively toggling of −1 and +1 values by matching and then applying a combining operation, for example adding. Although the method is described in the forgoing as relating to binary signals, it is also application to signals having more than two states which are to have watermark information added thereto as described later.

The watermark sequences S described in the foregoing are preferably designed to contribute a relatively low energy at lower frequencies, for example as presented in FIG. 1. However, the watermark sequences S are susceptible to being designed to exhibit similar behaviour at other frequency ranges. For example, the watermark sequence Sᵢ[n] can be replaced by another watermark sequence Sᵢ[n](−1)ⁿ which is capable of exhibiting relatively low energy in a frequency range close to half the sampling frequency, namely at fₛ/2. Sequences can be designed that exhibit relative low energy at other frequencies, for example fₛ/4.

As elucidated in the foregoing, the present invention concerns modifying digital signals, namely a series of samples, of which the sample can only assume a very limited number of values.

A standard 16-bit PCM signal is also such a signal, wherein the number of states that each sample can assume is two, namely logic 0 and logic 1 states. As a consequence, were it not for the present invention, the direct addition of two such signals would be substantially impossible without loss of data or data corruption occurring on account of the generation of illegal states.

Thus:

(a) to a sample value of −1, only the value 0 or +2 may be added; and

(b) to a sample value of +1, only the value 0 or −2 may be added.

However, as elucidated in the foregoing, the present invention is not limited to binary signals; for example, it can also be applied to 3-bit signals where the number of states that a 3-bit sample can assume is relatively limited.

A more generalized analysis of the foregoing will now be described and its relevance to other types of sequences and signals considered. In general, a signal X consisting of a sequence of k samples, namely k symbols, where each sample can assume any of the states from a pre-defined set B, is described mathematically by Equation 6 (Eq. 6):
XεB^{k} Eq. 6

Any 1-bit DSD signal X of k samples is defined, for example, by Equation 7 (Eq. 7):
Xε{−1,+1}^{k} Eq. 7

In contradistinction, a 2-bit signal X of k samples may, for example, be defined by Equation 8 (Eq. 8):
Xε{−3,−1,+1,+3}^{k} Eq. 8
and, likewise, a 3-bit signal X of k samples may, for example, be defined by Equation 9 (Eq. 9):
Xε{−7,−5,−3,−1,+1,+3,+5,+7}^{k} Eq. 9

Sequence S that may be combined with, for example added to, the sequence X as defined by Equation 6 is defined by Equation 10 (Eq. 10):
Y=X+2SεB^{k} Eq. 10
wherein the number of sequences S is limited. Thus, in the case of the aforementioned 1-bit signals conforming to Equation 7, the sequences S are limited as defined by Equation 11 (Eq. 11):
Sε{−1,0,+1} Eq. 11

Similarly, for 2-bit signals, Equation 12 (Eq. 12) pertains for the sequences S:
Sε{−3,−2,−1,0,+1,+2,+3}^{k} Eq. 12

It is to be appreciated that whether or not a sequence S is capable of being combined with, for example added to, the signal X as in Y=X+2S without generating illegal states depends on the actual states present in the signal X; unconditionally combining, for example adding, the signal X with the sequence S can result in
Y∉B^{k} Eq. 13
which is defined as an illegal state.

In certain practical applications of the present invention, illegal states can be tolerated in certain circumstances and are included in the category “desired legal states”; such applications relate to, for example, irreversible partial degradation of audio and/or video programme content for customer sampling or initial evaluation purposes prior to purchasing corresponding un-degraded programme content.

Thus, in applying the present invention, it is of interest to combine sequences S that, for a given state set B, introduce limited disturbance in a special frequency interval of the frequency spectrum of the signal X. For example, a series of sequences S according to Equation 14 (Eq. 14) are listed in Table 2 and their spectral characteristics presented in FIG. 5. These sequences have minimal disturbance in a frequency interval around 32fₛ where fₛ is a sampling frequency employed in generating the signal X; these sequences are susceptible to being combined with 1-bit DSD audio signals. Table 2 lists 10-best identified sequences S according to Equation 14 (Eq. 14):
Sε{−1,0,+1}¹² Eq. 14

which are selected to provide minimal disturbance around f=32 fₛ.

TABLE 2

| i | Sequence Sᵢ | | | | | | | | | | | | R (dB) |
|---|---|---|---|---|---|---|---|---|---|---|---|---|---|
| 1 | 1 | 1 | −1 | 0 | 1 | 0 | 0 | −1 | 0 | 1 | −1 | −1 | −60.77 |
| 2 | 1 | 1 | −1 | 0 | 1 | −1 | −1 | | | | | | −53.42 |
| 3 | 1 | 1 | −1 | −1 | −1 | −1 | 1 | 1 | | | | | −50.94 |
| 4 | 1 | 1 | −1 | −1 | −1 | −1 | 0 | −1 | 0 | 1 | −1 | −1 | −49.26 |
| 5 | 1 | 1 | −1 | 0 | 1 | 0 | 1 | 1 | 1 | 1 | −1 | −1 | −49.26 |
| 6 | 1 | 1 | −1 | −1 | 0 | 1 | 1 | −1 | −1 | | | | −49.26 |
| 7 | 1 | 1 | −1 | 0 | 1 | 0 | 1 | 0 | −1 | 1 | 1 | | −48.86 |
| 8 | 1 | 1 | −1 | −1 | 0 | 0 | −1 | −1 | 1 | 1 | | | −47.47 |
| 9 | 1 | 1 | 0 | 1 | 0 | −1 | 0 | −1 | −1 | | | | −47.43 |
| 10 | 1 | 1 | −1 | −1 | 0 | 0 | 0 | 1 | 1 | −1 | −1 | | −46.17 |

With reference to Table 2 and its associated FIG. 5, it will be appreciated that the signal X and the sequence S can be combined by one or more mathematical processes, for example addition, subtraction, multiplication by −1, exclusive-OR to mention a few examples; other types of mathematical operations such as multiplication are also feasible within the scope of the present invention.

For the signal X being a 2-bit signal according to Equation 8 in the foregoing having corresponding sequences S limited as defined in Equation 12, examples of some sequences of maximum length of 5 symbols that have a relatively low disturbance in a frequency interval 0≦f≦fₛ are listed in Table 3. For comparison, performances of sequences S=[1,−1] and S=[1] is also shown. Moreover, frequency spectra of four best sequences are illustrated in FIG. 6.

TABLE 3

| I | Sequence: Sᵢ | | | | | R (dB) |
|---|---|---|---|---|---|---|
| 1 | 1 | −3 | 3 | −1 | | −68.95 |
| 2 | 1 | −2 | 0 | 2 | −1 | −62.94 |
| 3 | 1 | −2 | 1 | | | −47.33 |
| 4 | 1 | −1 | −2 | 3 | −1 | −47.21 |
| 5 | 1 | −3 | 2 | 1 | −1 | −47.21 |
| 6 | 1 | −2 | 2 | −2 | 1 | −41.33 |
| 7 | 1 | −1 | −1 | 1 | | −41.31 |
| 8 | 2 | −3 | −1 | 3 | −1 | −41.25 |
| 9 | 1 | −3 | 1 | 3 | −2 | −41.25 |
| 10 | 1 | −1 | 0 | −1 | 1 | −37.80 |
| 11 (comparison) | 1 | −1 | | | | −24.93 |
| 12 (comparison) | 1 | | | | | 0 |

Earlier, examples of sequences S were described, for example with reference to FIG. 1, which are susceptible to causing minimal disturbances in a frequency interval around f=0 Hz, for example in an interval 0≦f≦fₛ or −fₛ≦f≦fₛ. In FIG. 7, there is shown, for comparison purposes, a full-frequency spectrum in a range −32fₛ≦f≦32fₛ corresponding to four best sequences S for Sε{−1,0,+1}¹² providing minimal disturbance around f=0 Hz, the sequences S being listed in Table 2. In the foregoing, it is elucidated that sequences S can be designed to introduce minimal disturbance at other frequency intervals encompassing the signal X. In particular, the inventors have appreciated that it is possible to devise examples of the sequence S that exhibit minimal disturbance in a frequency range around other frequencies than f=0 Hz.

If a given sequence S is modified by modulation with a carrier C, then the frequency spectrum of the newly obtained shifted sequence S′ is a shifted version of the spectrum of the sequence S. Beneficially, the carrier C is defined according to Equation 15 (Eq. 15):
c[n]=(−1)ⁿ Eq. 15

Application of the carrier C to the sequence S is capable of shifting it by 32fₛ as provided by Equation 16 (Eq. 16):
s′[n]=s[n](−1)ⁿ Eq. 16

In consequence, a combination of the shifted sequence S′ with the signal X results in a frequency disturbance for which minimal disturbance has changed from f=0 Hz to f=32fₛ. With regard to applying the carrier C to shift the sequence S, such shifting is trivial if the sequence Sε{−1,0,+1}^{k} where shifting results in the shifted sequence S′ε{−1,0,+1}^{k}. A list of shifted sequences are provided in the foregoing Table 2 with corresponding four best spectra presented in FIG. 5.

If, in combining the signal X with the sequence S, complex values are permitted to arise, it is envisaged that resulting spectra can be different for negative and positive frequencies. The aforesaid carrier C can be conveniently defined in complex form according to Equation 17 (Eq. 17):
c[n]=jⁿ Eq. 17
wherein j=\sqrt{−1}
and its application to the signature S is to shift the spectrum of a corresponding shifted sequence S′ to 16fₛ as described by Equation 18 (Eq. 18):
s′[n]=s[n]c[n]=s[n]jⁿ Eq. 18

For the carrier C of Equation 17, it is trivial if the sequence S has a set of states Sε{−j,−1,0,+1,+j}^{k} that the shifted sequence will have a corresponding set of states S′ε{−j,−1,0,+1,+j}^{k} also. Ten best sequences S from Table 1 are modulated by jⁿ and corresponding modulated sequences listed in Table 4.

TABLE 4

| I | Sequence: Sᵢ | | | | | | | | | | | R (dB) |
|---|---|---|---|---|---|---|---|---|---|---|---|---|
| 1 | 1 | −j | 1 | 0 | 1 | 0 | −j | 0 | −j | 1 | −j | −60.77 |
| 2 | 1 | −j | 1 | 0 | 1 | 1 | | | | | | −53.42 |
| 3 | 1 | −j | 1 | −j | −1 | −1 | j | | | | | −50.94 |
| 4 | 1 | −j | 1 | −j | −1 | 0 | −j | 0 | −j | 1 | −j | −49.26 |
| 5 | 1 | −j | 1 | 0 | 1 | −1 | j | 1 | −j | 1 | −j | −49.26 |
| 6 | 1 | −j | 1 | −j | 0 | −1 | −j | −1 | | | | −49.03 |
| 7 | 1 | −j | 1 | 0 | 1 | −1 | 0 | −1 | −j | −1 | | −48.86 |
| 8 | 1 | −j | 1 | −j | 0 | 1 | −j | 1 | −j | | | −47.47 |
| 9 | 1 | −j | 0 | j | 0 | 0 | −j | −1 | | | | −47.43 |
| 10 | 1 | −j | 1 | −j | 0 | 0 | j | 1 | j | 1 | | −46.17 |

Spectra of four best sequences from Table 4 are plotted on a graph of FIG. 8 where an asymmetrical distribution is clearly identifiable.

The method of the invention, namely combining selected sequences directly with signals to “imprint” the sequences upon the signals has numerous practical technical applications, such applications including one or more of:

(a) special configurations of sigma delta modulators for analogue to digital signal conversion;

(b) special configurations of multi-bit analogue to digital converters, for example modified versions of a converter of a type described in “A multi-bit sigma-delta ADC for multi-mode receivers” by Miller and Petrie, presented in Custom Integrated Circuits Conference, 2002. Proceedings of the IEEE 2002, May 2002, pp. 191-194; and

(c) special configurations of complex sigma-delta converters, for example modified versions of a converter of a type described in “A fourth order continuous-time complex sigma-delta ADC for low-IF GSM and edge receivers” by Basedau et al., VLSI Circuits 2003 as published in Digest of Technical Papers, 2003 Symposium June, 2003, pp. 75-78.

The method of the invention is susceptible to practical application in watermarking audio and/or video programme content, for example music and/or video content conveyed via communication networks such as the Internet, and on data carriers, for example optical data carriers such as CD's, DVD's. Such watermarking is of benefit in discouraging unauthorised copying, namely pirating, of programme content and can be used as evidence to take legal action against counterfeiters, for example injunctions and/or delivery up of counterfeit copies. Conversely, in a manner akin to currency bank notes, such watermarking can also be used for authentication purposes so customers can verify that they have purchased a bona fide original programme content product.

It will be appreciated that embodiments of the invention described in the foregoing are susceptible to being modified without departing from the scope of the invention as defined by the accompanying claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

1. A method of processing a serial data signal to generate a corresponding transformed signal, the method including the steps of:
(a) providing one or more signature sequences;
(b) analysing the serial data signal to determine therein one or more signal sequences for which holds that combining such one or more signal sequences with said one or more signature sequences does not result in generation of illegal states; and
(c) combining one or more of the determined signal sequences of the serial data signal with said one or more signature sequences so as to transform the serial data signal into the transformed signal.

2. A method according to claim 1, wherein the serial data signal is a 1-bit data signal in binary format, and the one or more signature sequences are arranged to be directly combinable with the serial data signal to generate the transformed signal in binary format, preferably such combination involving addition and/or subtraction and/or exclusive-OR operations.

3. A method according to claim 1, wherein the serial data signal is arranged such that its series of symbols have substantially similar significance.

4. A method according to claim 1, wherein the one or more signature sequences are useable to reversibly transform the transformed signal to regenerate a copy of the serial data signal therefrom.

5. A method according to claim 1, wherein a plurality of signature sequences is employed in the method.

6. A method according to claim 5, arranged in operation to switch dynamically between the sequences when transforming the serial data signal into the transformed signal.

7. A method according to claim 1, wherein the one or more signature sequences are each two or more symbols long.

8. A method according to claim 1, wherein the one or more signal sequences for which holds that combining such one or more signal sequences with said one or more signature sequences does not result in generation of illegal states are selected according to a perceptual model to obtain a preferred perceived characteristic in the transformed signal.

9. A method according to claim 1, wherein the serial data signal and the transformed signal are 1-bit audio signals, and the combination of the one or more signature sequences is performed directly on the serial data signal without transforming to another signal format.

10. A method according to claim 1, arranged to embed a watermark in the serial data signal so that the transformed signal is a watermarked version of the serial data signal.

11. An apparatus (100) for implementing the method according to claim 1, the apparatus being arranged to receive the serial data signal and output the transformed data.

12. Transformed data generated using the method according to claim 1.

13. A data carrier including stored thereon transformed data according to claim 12.

14. Computer software operable when executed on a computing device to implement the method according to claim 1.

15. A method of processing a transformed signal to regenerate a corresponding decoded serial data signal, the method including the steps of:
(a) providing one or more signature sequences;
(b) analysing the transformed signal to determine therein one or more signal sequences for which holds that combining such one or more signal sequences with said one or more signature sequences does not result in generation of illegal states; and
(c) combining one or more of the determined signal sequences of the transformed signal with said one or more signature sequences so as to transform the transformed signal to regenerate therefrom the decoded serial data signal.

16. An apparatus for implementing the method according to claim 15, the apparatus being operable to receive the transformed data signal and output the decoded serial data signal data.

17. Computer software operable when executed on a computing device to implement the method according to claim 15.
